(19) United States
(12) Patent Application Publication
(10) Pub. No.: US 2005/0172789 A1
(43) Pub. Date: Aug. 11, 2005

(54) Device for playing music on booting a motherboard

(75) Inventors: Hung-Ta Hsu, Hsinchu City (TW); Chin-Hsiang Wang, Hsinchu City (TW); Peng-Chou Peng, Jhubei City (TW); Yu-Cheng Liao, Taipei City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 10/972,416

(22) Filed: Oct. 26, 2004

(30) Foreign Application Priority Data
Jan. 29, 2004 (TW) 09310968

(51) Int. Cl. G10H 1/36; G10H 7/00

(52) U.S. Cl. 84/645

(57) ABSTRACT

A device for playing music on booting a motherboard includes a music play unit and a storage device. The music play unit is connected to a system bus arranged on the motherboard in order to receive a music play instruction as the motherboard is activated, thereby playing corresponding music data based on the music play instruction. The storage device stores music data to be played, wherein the music play unit reads music data from the storage device based on the music play instruction in order to play music before an operating system or a standby mode is entered.

### BACKGROUND OF THE INVENTION

1. Field of the Invention

The invention relates to a music player on a motherboard and, more particularly, to a device capable of automatically playing music on booting a motherboard.

2. Description of Related Art

FIG. 1 shows a hardware block diagram of a typical personal computer (PC). As shown, the PC includes a processor 110, a north-bridge chip 120, a south-bridge chip 130, an AC'97 Codec 140, a BIOS (basic input/output system) 150. The BIOS 150 is connected to the south-bridge chip 130 through an LPC bus 160. When the PC is playing music, the processor 110 executes associated settings to send music data to the Codec 140 for playing, or the Codec 140 directly reads music data for playing.

In the aforementioned PC configuration, during the time after booting the motherboard and before entering an operating system (OS), the processor 110 is busy to execute various tests and settings on the motherboard. For example, memory test, memory and IO address tests and settings in various PCI (peripheral component interconnect) cards on the PCI bus, keyboard and mouse tests are executing during the time that need a lot of computation power of the processor 110, so that the processor 110 is busy and cannot send music data to the AC'97 Codec 140 for play. Therefore, on booting the motherboard, a user can do nothing but waiting in front of the PC 110. In addition, when the computer enters a standby mode, the processor 110 on the computer also enters a sleep mode and stop to apply the AC'97 Codec for playing music.

Therefore, it is desirable to provide an improved device for playing music on booting a motherboard to mitigate and/or obviate the aforementioned problems.

### SUMMARY OF THE INVENTION

The object of the invention is to provide a device for playing music on booting a motherboard, which can play music when a host with the motherboard is booting or it enters a standby mode.

In accordance with one aspect of the present invention, there is provided a device for playing music on booting a motherboard. The device includes a music play unit and a storage device. The music play unit is connected to a system bus arranged on the motherboard in order to receive a music play instruction as the motherboard is booting, thereby playing corresponding music data based on the music play instruction. The storage device stores music data to be played. The music play unit reads music data from the storage device based on the music play instruction in order to play music before an operating system or a standby mode is entered.

In accordance with another aspect of the present invention, there is provided a device for playing music on booting a motherboard, which comprises a south-bridge chip and a music play unit. The south-bridge chip is connected to peripherals of the motherboard for handle. The music play unit is connected to an LPC system bus of the south-bridge chip in order to receive a music play instruction through the LPC system bus as the motherboard is booting, thereby playing corresponding music data based on the music play instruction. The storage device stores music data to be played by the music play unit. Namely, the music play unit reads the corresponding music data from the storage device based on the music play instruction in order to play music.

Other objects, advantages, and novel features of the invention will become more apparent from the following detailed description when taken in conjunction with the accompanying drawings.

### BRIEF DESCRIPTION OF THE DRAWINGS

FIG. 1 shows a hardware block diagram of a typical personal computer (PC);

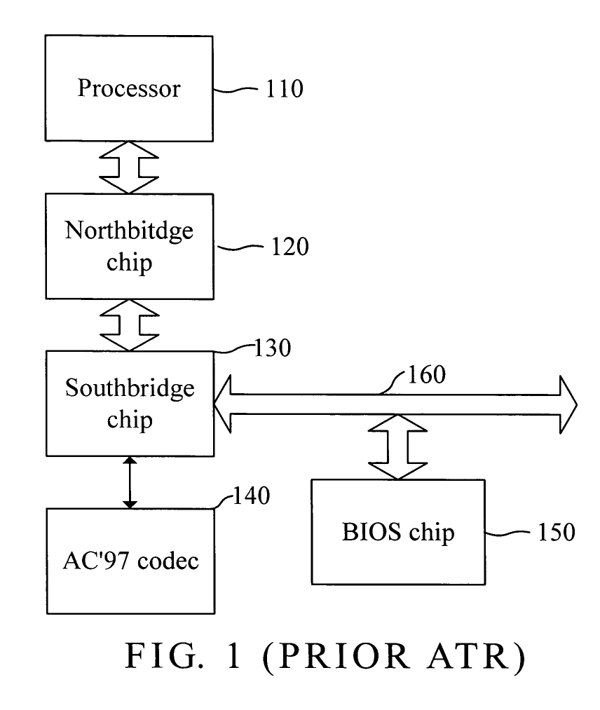

FIG. 2 is a block diagram of a device for playing music on booting a motherboard in accordance with an embodiment of the invention;

FIG. 3 is a flowchart in accordance with the invention;

FIG. 4 is another flowchart in accordance with the invention;

FIG. 5 is a block diagram of another embodiment in accordance with the invention; and

FIG. 6 is a block diagram of a further embodiment in accordance with the invention.

### DETAILED DESCRIPTION OF THE PREFERRED EMBODIMENT

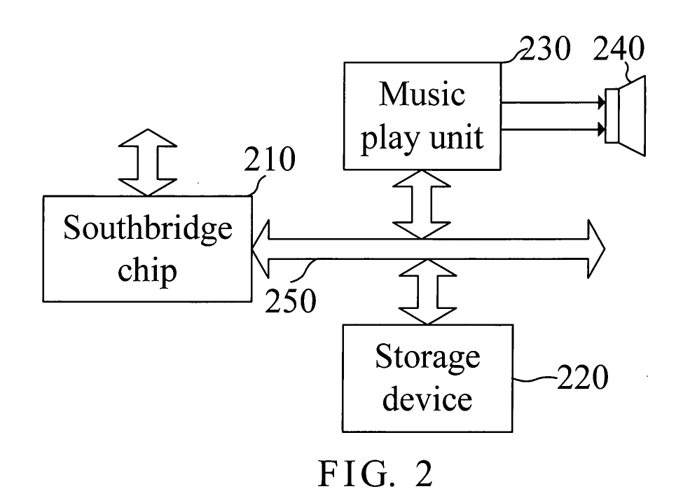

FIG. 2 is a block diagram of a device for playing music on booting a motherboard in accordance with a preferred embodiment of the invention. As shown, the motherboard consists of a south-bridge chip 210, a storage device 220, a music play unit 230 and a speaker 240. The storage device 220 and the music play unit 230 are connected to the south-bridge 210 through an LPC bus 260. The music play unit 230 reads music data from the storage device 220 for being decoded. The decoded music data by the music play unit 230 is played through the speaker 240.

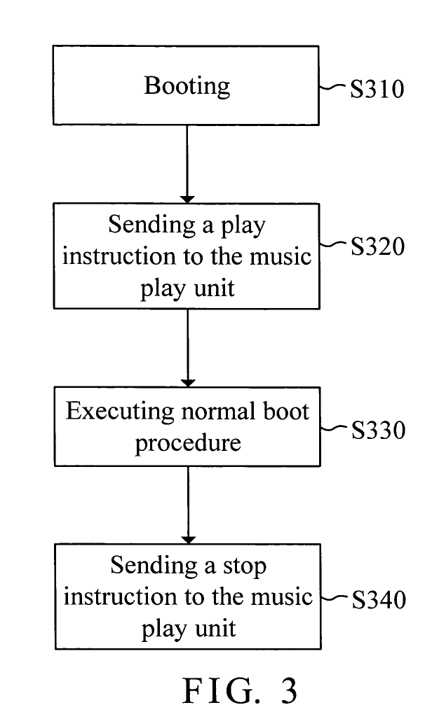

FIG. 3 is a flowchart in accordance with the invention. Firstly, in step S310, a personal computer (PC) enters a booting routine as a user presses a power-on button or a reset key. At this point, a processor reads an instruction from a predetermined address (such as 0xFFFFFFF0_{H} or 0x0000000_{H}) for execution. Typically, the predetermined address is mapped to a basic input output system (BIOS). Next, some internal settings of the processor are processed. For example, a memory management unit (MMU) is initialized.

In step S320, the processor reads a section of program from the BIOS and sends a play instruction to the music play unit 230 to play music by executing the program, the play instruction includes a command, a MIDI (Music Instrument Digital Interface) address and a speech address. The music play unit 230 reads MIDI data to decode from the storage device 220 based on the MIDI address and accordingly drives the speaker 240. As such, the music play unit 230 can automatically play music without help of the processor, so as not to increase loading on the processor.

In step S330, the processor enters a normal boot procedure after sending the play instruction to the music play unit 230. As such, in the entire boot procedure, the music play unit 230 continuously and automatically drives a speaker to play music, thereby avoiding boring to wait for booting.

In step S340, when entering the OS, a driver is executed to send a stop instruction to the music play unit 230 to stop playing music. Namely, after the host enters the OS, music play is automatically stopped, so as not to interfere with use of the host.

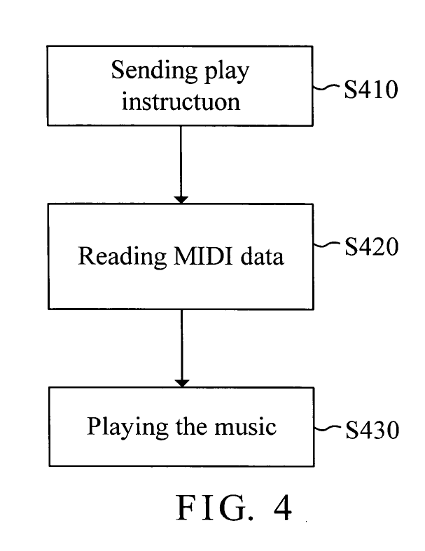

In this embodiment, FIG. 4 is a flowchart in accordance with the invention when the host is to enter the standby mode. As such, the driver sends the play instruction to the music play unit 230 (step S410). The music play unit 230 reads the MIDI data to decode from the storage device 220 based on the MIDI address (step S420) and accordingly drives the speaker 240 (step S430). As such, when the processor 110 enters the sleep mode, the music play unit 230 can automatically play music without help of the processor. Therefore, a user can listen to the music when the host is in the standby mode.

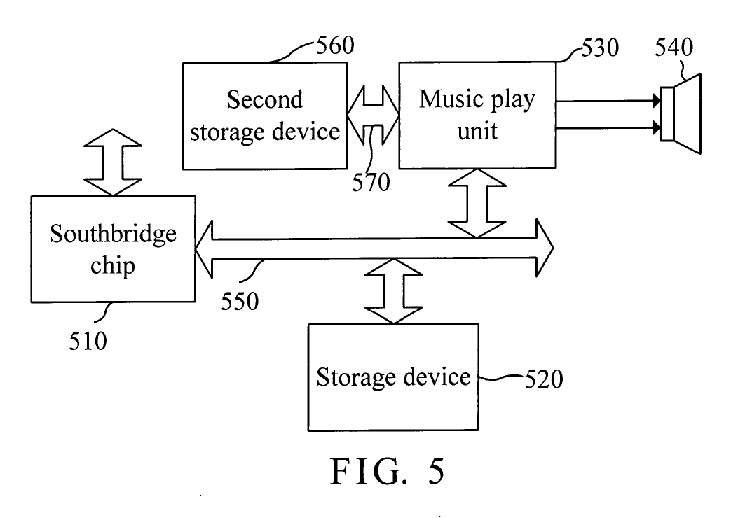

Because this embodiment applies the MIDI format, required size for the music data is very small and can be stored in the storage device 220 along with the typical BIOS without affecting the performance of processor access to the BIOS. FIG. 5 is a block diagram of another embodiment. As shown, the music data is stored in a second storage device 560 and the music play unit 530 accesses the music data through a local bus 570. Due to the dedicated storing areas, not only more pieces of music in the MIDI format but also pieces of music in other formats such as a WAV format or PCM format can be stored.

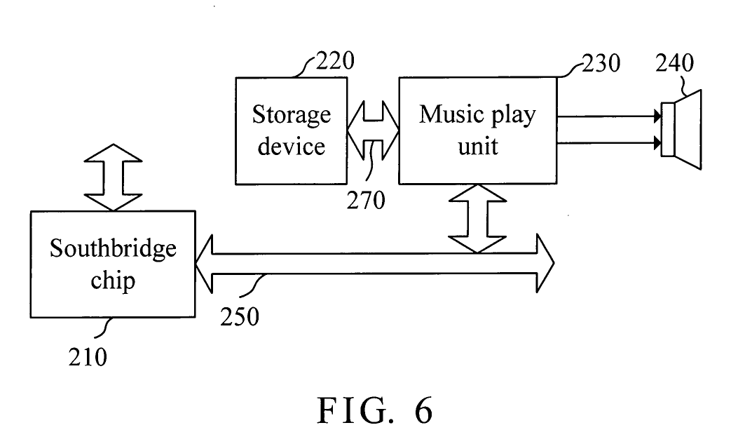

FIG. 6 is a block diagram of a further embodiment. As shown, the music data and the BIOS are stored concurrently in the storage device 220 that connects to the music play unit 230 through a local bus 270. For accessing the BIOS, the processor requires passing through the LPC bus 250 and the music play unit 230. As such, the music play unit 230 can be designed as a slave device for simplification of associated circuitry design of the music play unit 230, thereby saving the cost.

Besides the music data, the storage device 220 can store other speech data such as a fragment of greetings or advertisements. Accordingly, the music play unit 230 can play the fragment of greetings or advertisements when the host is booting, so that a user can hear the fragment of greetings such as ‘Apple Computer welcomes you’ as booting the host, thereby adding use-friendly to the host.

In view of the foregoing, the invention essentially adds the music play unit 230 to the motherboard through the LPC bus 250, thereby avoiding boring to wait for booting and allowing playing music when the host is in the standby mode.

Although the present invention has been explained in relation to its preferred embodiment, it is to be understood that many other possible modifications and variations can be made without departing from the spirit and scope of the invention as hereinafter claimed.

1. A device for playing music on booting a motherboard, comprising:
a music play unit connected to a system bus arranged on the motherboard in order to receive a music play instruction as the motherboard is booting, thereby playing corresponding music data based on the music play instruction; and
a storage device for storing data that includes at least one section of music data to be played by the music play unit,
wherein the music play unit reads the corresponding music data from the storage device based on the music play instruction in order to play music.

2. The device as claimed in claim 1, wherein the storage device is a non-volatile memory.

3. The device as claimed in claim 1, wherein the system bus is an LPC bus of a south-bridge chip on the motherboard.

4. The device as claimed in claim 3, wherein the storage device is connected to the LPC bus.

5. The device as claimed in claim 1, wherein the storage device is connected to a local bus of the music play unit.

6. The device as claimed in claim 5, wherein the storage device is integrated into the music play unit.

7. The device as claimed in claim 1, wherein the music play instruction is a MIDI (Music Instrument Digital Interface) instruction.

8. The device as claimed in claim 1, wherein the storage device stores speech data of greetings and advertisements.

9. A device for playing music on booting a motherboard, comprising:
a south-bridge chip connected to peripherals of the motherboard for handling the peripherals;
a music play unit connected to an LPC system bus of the south-bridge chip in order to receive a music play instruction through the LPC system bus as the motherboard is booting, thereby playing corresponding music data based on the music play instruction; and
a storage device for storing data that includes at least one section of music data to be played by the music play unit,
wherein the music play unit reads the corresponding music data from the storage device based on the music play instruction in order to play music.

10. The device as claimed in claim 9, wherein the storage device is a non-volatile memory.

11. The device as claimed in claim 10, wherein the non-volatile memory is connected to the LPC bus.

12. The device as claimed in claim 9, wherein the storage device is connected to a local bus of the music play unit.

13. The device as claimed in claim 12, wherein the storage device is integrated into the music play unit.

14. The device as claimed in claim 9, wherein the music play instruction is a MIDI instruction.

15. The device as claimed in claim 9, wherein the storage device stores speech data of greetings and advertisements.

16. A device for playing music on booting a motherboard, comprising:
a south-bridge chip connected to peripherals of the motherboard for handling the peripherals;
a music play unit connected to an LPC system bus of the south-bridge chip in order to receive a music play instruction through the LPC system bus as the motherboard is booting, thereby playing corresponding music data based on the music play instruction;
a storage device for storing BIOS data to be executed on booting the motherboard; and
a second storage device for storing music data to be played by the music play unit,
wherein the music play unit reads the corresponding music data from the second storage device based on the music play instruction in order to play music.

17. The device as claimed in claim 16, wherein the storage device is connected to the LPC bus.

18. The device as claimed in claim 16, wherein the second storage device is a non-volatile memory.

19. The device as claimed in claim 18, wherein the second storage device is connected to a local bus of the music play unit.

20. The device as claimed in claim 18, wherein the second storage device is integrated into the music play unit.

21. The device as claimed in claim 16, wherein the music play instruction is a MIDI (Music Instrument Digital Interface) instruction.

22. The device as claimed in claim 16, wherein the music data is WAV format or PCM format.
